(19) United States
(12) Patent Application Publication
(10) Pub. No.: US 2008/0143136 A1
(43) Pub. Date: Jun. 19, 2008

(54) Device for Automatically Fixing a Dashboard to a Motor Vehicle Body Shell

(75) Inventor: Christian Branchereau, Herblay (FR)

Correspondence Address: YOUNG & THOMPSON, 209 Madison Street, Suite 500, ALEXANDRIA, VA, 22314, US

(73) Assignee: FAURECIA INTRTIEUR INDUSTRIE, NANTERRE (FR)

(21) Appl. No.: 11/883,598

(22) PCT Filed: Feb. 8, 2006
(86) PCT No.: PCT/FR2006/000288

§ 371 Date: Aug. 2, 2007

(30) Foreign Application Priority Data
Feb. 11, 2005 (FR) 0501433
Aug. 31, 2005 (FR) 0508937

(51) Int. Cl. B62D 25/14

(52) U.S. Cl. 296/72

(57) ABSTRACT

A device including: a male member (11) integral with one first element (1) which is either the instrument panel or the body shell; and a female member (12) connected to the second element (3) which is either the instrument panel or the body shell, and designed to receive the male member (11) in mutual engagement along an engagement axis (X). The female member (12) includes automatically triggered axial clamping elements (33, 35, 37) activated by the engagement of the male member (11) into the female member (12), over a range of axial positions.

The invention relates to a device for automatically fixing a dashboard to a motor vehicle body, comprising:
a male member which is fixedly joined to a first element from the dashboard and the body, and
a female member which is connected to the second element from the dashboard and the body, and which is provided so as to receive the male member with mutual engagement along an engagement axis.

A device of this type is described, for example, in the document FR 2 830 908.

In a device of this type, the fixing is carried out by means of the positioning of the dashboard in the vehicle, without it being necessary for the operator to access the fixing device directly.

A significant disadvantage of known devices of this type is that they operate correctly only when the relative positioning of the male and female members, when the dashboard is mounted, is completely controlled and can be reproduced from one vehicle to the next.

Since components having large dimensions are involved, there are significant dimensional variations which affect the operation of the fixing members.

An object of the invention is to overcome this disadvantage and to provide an automatic fixing device of the above-mentioned type, which allows variations of this type to be compensated for, and allows a clearance adjustment to be carried out in the direction of mutual engagement of the fixing members.

An object of the invention is also to provide a clearance adjustment in a transverse direction relative to the engagement direction, and to minimise the variations of the securing torque with the dimensional variations which affect the fixing members.

To this end, the invention relates to a fixing device of the type set out above, in which the female member comprises axial securing means which have automatic activation and which are activated by the engagement of the male member in the female member, over a range of relative axial positions.

According to other optional features of the invention:
the male member comprises an engagement portion which forms a cam follower, and the securing means comprise an associated cam which is mounted so as to rotate in a fixed body of the female member, a resilient member which is provided in order to urge the cam in terms of rotation, and a releasable member for locking the cam, which is provided in order to selectively lock the cam in terms of rotation in a neutral standby position in which the cam and the cam follower can come into mutual engagement and in which the resilient member is pretensioned, or release the cam in order to bring about the securing, in accordance with the mutual engagement position of the male member and the female member;
the locking member is mounted so as to slide axially in the fixed body of the female member;
the cam is fixedly joined to a shaft which forms the axis of rotation thereof, the shaft and the locking member being provided with complementary shapes which can mutually engage in order to ensure that they are fixedly joined in terms of rotation, and disengage by means of relative axial displacement;
the fixed body is provided with a hole for introducing a tool, which is provided in order to place the locking member in the locking position thereof when the female member is assembled, the hole being axially aligned with the locking member;
the fixed body comprises a hollow cylindrical portion which is formed with an opening for engagement of the male member, and in which the securing means are arranged;
the cam and the fixed body are provided with visual means for indicating the angular position of the cam about the axis of rotation thereof, which is indicative of the state of the securing means;
the fixed body is provided at the outer side with a threaded rod which allows the female member to be fixed on the second element by means of screwing;
the threaded rod is formed with an axial conduit which opens in the fixed body, and which defines the hole for introduction of the tool;
the cam has a profile which has, successively, a linear entry portion for clearance adjustment, and a securing portion in the form of an arc of a circle which is off-centre relative to the axis of rotation of the cam;
the entry portion and the securing portion extend in an adjacent manner;
the cam is provided so as to rotate through an angle substantially equal to 90°, between the neutral standby position and the final securing position thereof; and
the male member is fixed to the dashboard, whilst the female member is fixed to the body.

A specific embodiment of the invention will now be described in greater detail with reference to the appended drawings, in which:

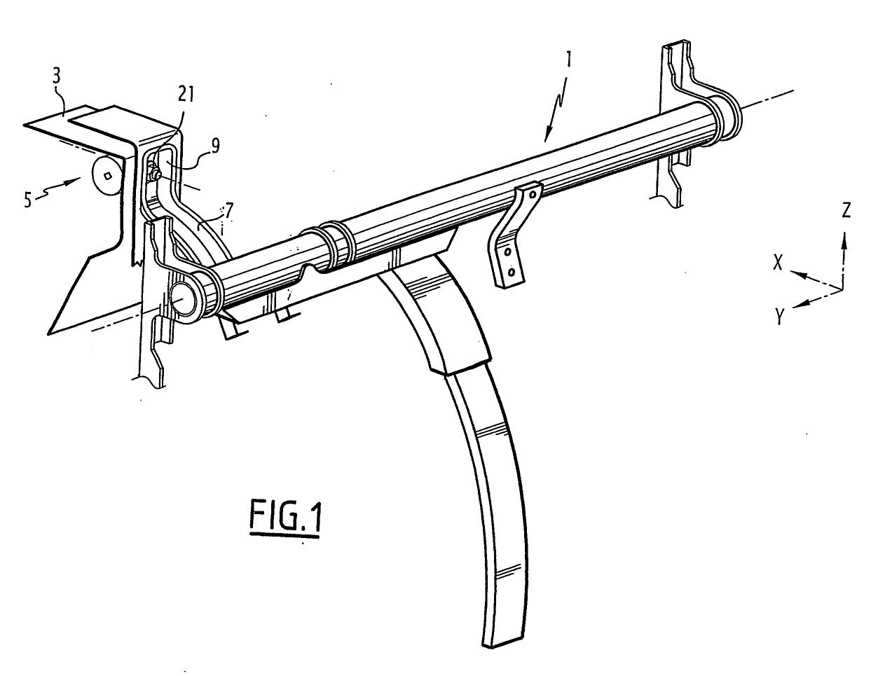

FIG. 1 is a schematic perspective view of a dashboard cross-member, a vehicle body portion, and a fixing device in accordance with the invention, in an operating position, which brings about the fixing of this cross-member to this body portion;

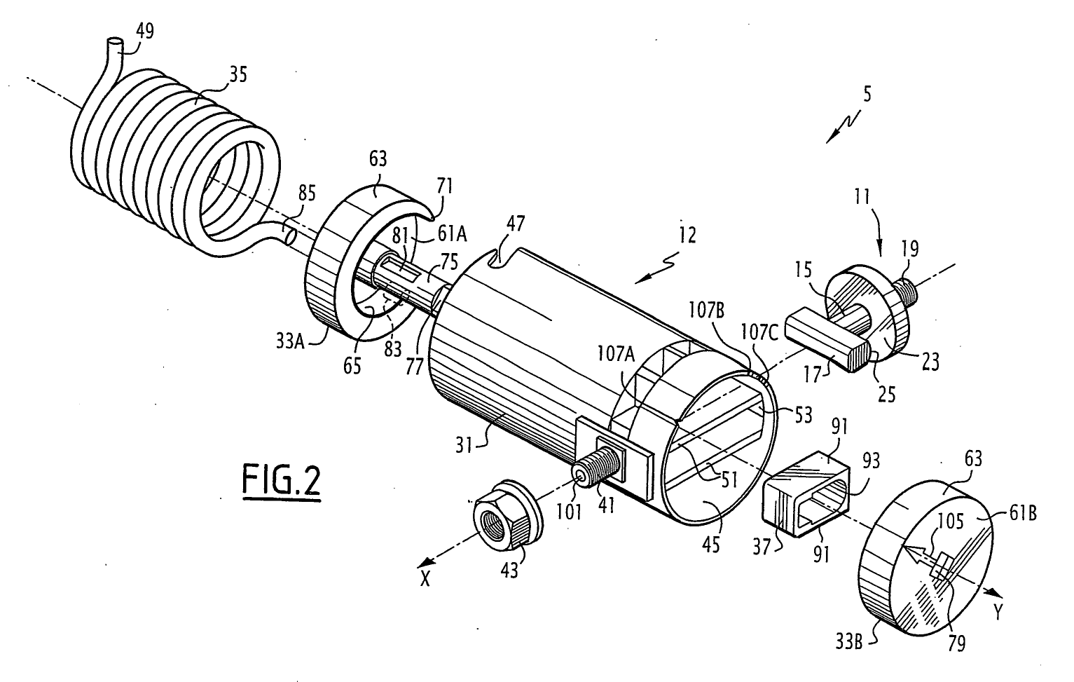

FIG. 2 is an exploded perspective view of a fixing device according to the invention;

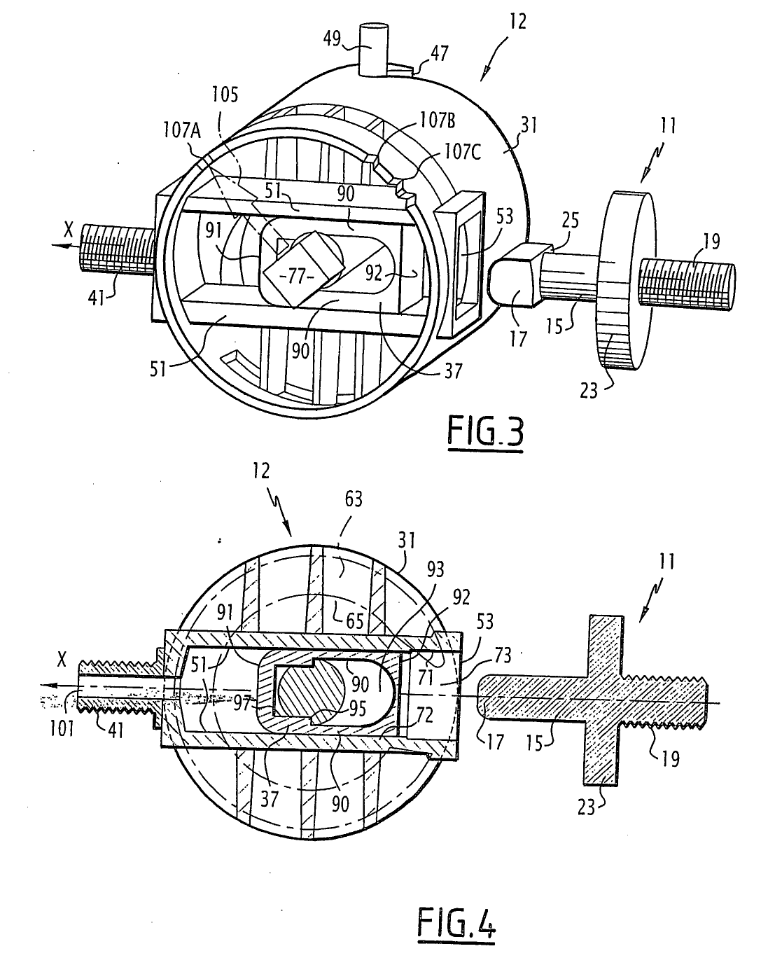

FIG. 3 is a perspective view of the fixing device of FIG. 2, the female member being assembled and the male member waiting to be engaged in the female member;

FIG. 4 is a sectioned view, along the axial centre plane 4-4, of the device of FIG. 3;

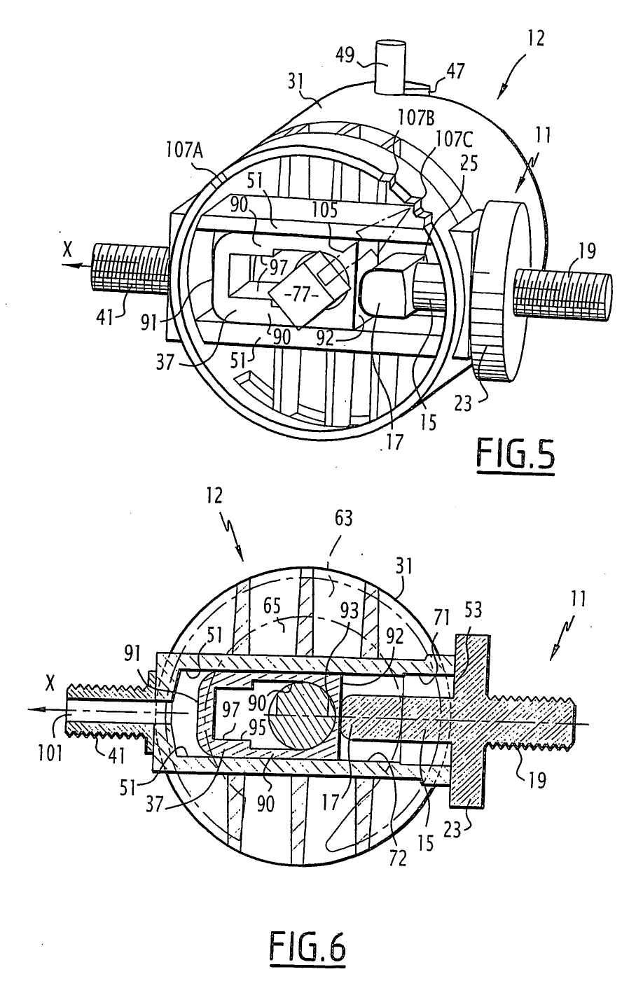

FIG. 5 is a view similar to FIG. 3, with the male member being in a configuration engaged and secured in the female member;

FIG. 6 is a view similar to FIG. 4, in the engagement configuration of FIG. 5; and

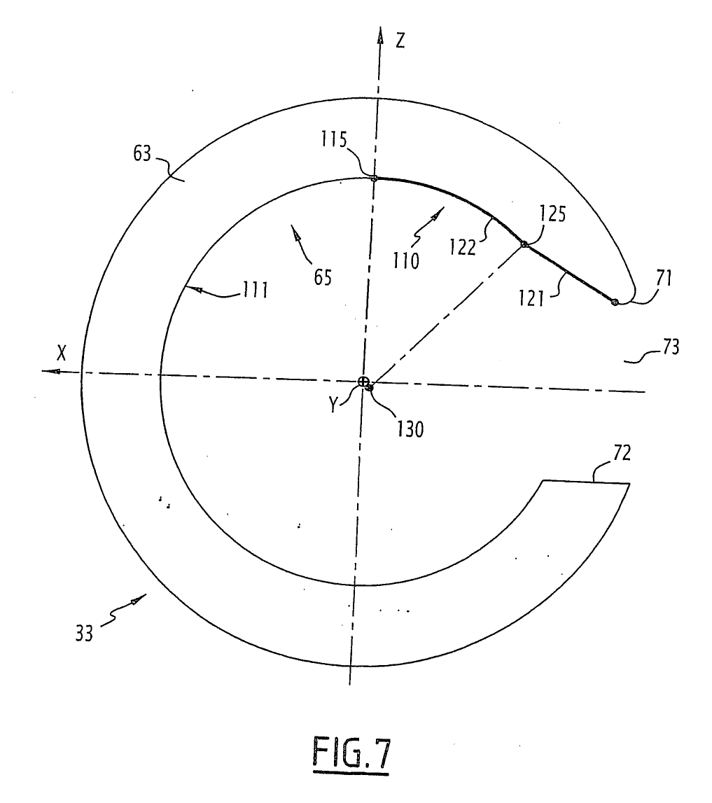

FIG. 7 is a schematic sectioned view of the cam in a plane orthogonal relative to the rotation axis thereof, illustrating the cam profile.

FIG. 1 illustrates a cross-member 1 of the dashboard which constitutes a structural element (or framework) of the dashboard, fixing the dashboard to a structural element of the vehicle.

The structural element of the vehicle, which is referred to generically as “body” or “body portion”, and to which the cross-member 1 is fixed, is illustrated with the reference numeral 3. This structural element 3 of the vehicle is a cross-member referred to as the “lower windscreen cross-member”.

The rigid fixing of the cross-member 1 to the body portion 3 is carried out by means of at least one fixing device 5 in accordance with the invention.

The cross-member 1 is provided with a fixing lug 7, referred to as a “lower windscreen cross-member connection”, which has a support and fixing portion 9 which is directed towards the body portion 3 and in the region of which the fixing is carried out by means of the device 5.

A single fixing device 5 is illustrated in the Figure, it being understood that the cross-member 1 is fixed at a plurality of points distributed along the length of the cross-member, preferably at three points, using fixing devices which are preferably identical or similar to that illustrated.

FIG. 1 illustrates the system of axes X, Y and Z which define the conventional orientation of a vehicle and in which:
the X axis is the longitudinal axis of the vehicle, orientated in a direction from the rear to the front,
the Y axis is the transverse axis orientated from right to left, and
the Z axis is the vertical axis orientated from the bottom to the top.

In the following description, all the terms for orientation and position should be understood with reference to this system of axes X, Y and Z.

As indicated in FIG. 1, the fixing device 5 has an axis of engagement which is directed substantially along the longitudinal axis X.

The term “axial” is intended to refer to an orientation along the axis of engagement.

Consequently, it is assumed that the axis of engagement and the longitudinal axis X are in alignment.

With reference to FIGS. 2 to 6, the fixing device 5 and the operation thereof will now be described.

The fixing device 5 comprises a male member 11 which is fixedly joined to the dashboard 1 and a female member 12 which is fixedly joined to the body portion 3.

The male member 11 is substantially constituted by a T-shaped hook which has an axial rod 15 and a transverse bar 17 which forms an engagement portion.

The axial rod 15 has a threaded free end portion 19 which is provided in order to provide rigid fixing to the structural element 1 of the dashboard using a complementary nut 21 (as illustrated in FIG. 1).

The male member 11 is further provided with an annular stop 23 in order to limit the engagement of the male member 11 in the female member 12.

As can be seen more clearly in FIGS. 3 to 6, the transverse bar 17 has a cross-section which is generally rectangular, and a rear face 25, that is to say, the one which is directed towards the free end of the T-shaped hook (the term rear being considered with reference to the direction of engagement), which is clearly convex.

The rear face 25 of the transverse bar 17 defines a fastening shoulder which forms a cam follower.

The female member 12 comprises a tubular body 31 which has a generally cylindrical shape and securing means which are arranged in the body 31. These securing means comprise a cam 33 which is formed by two portions 33A, 33B, a torsion spring 35 which is provided in order to urge the cam 33 in terms of rotation and a lock 37 which is provided in order to lock the cam 33 in terms of rotation counter to the biasing of the torsion spring.

The tubular body 31 comprises, protruding axially outwards, a threaded rod 41 which allows the female member 11 to be fixed to the body portion 3 using a complementary nut 43. This nut 43, referred to as an “anti-theft” nut, can be accessed by an operator in order to enable the disassembly of the dashboard.

The tubular body 31 is open at each of the two ends thereof, and comprises, at a first of these ends, a compartment 45 in which the cam 33 and the lock 37 are arranged.

Starting from the other end thereof, the tubular body 31 internally forms a compartment which is adjacent to the compartment 45 and in which the spring 35 is arranged. A notch 47 is formed at this end of the body 31 in order to receive and lock a corresponding end 49 of the torsion spring 35.

In a symmetrical manner relative to the horizontal axial plane, the tubular body 31 is formed internally with two planar support and guiding walls 51.

The tubular body 31 is further formed with an opening 53 for engagement of the male member 11. This opening 53 opens inside the tubular body 31 between the support and guiding walls 51.

As indicated above, the cam 33 is produced in two portions 33A and 33B, each being provided in order to co-operate with a corresponding portion of the bar 17, at one side or the other of the axial rod 15. Each cam portion 33A, 33B comprises a respective base plate 61A, 61B and a peripheral edge 63 which is of the same general C-like shape and whose inner surface 65 defines a cam path. The cam path 65 is provided in order to co-operate with the cam follower which is constituted by the rear face 25 of the bar 17.

Between the first end 71 and the second end 72 thereof, the C-shaped edge 63 has an inner profile which defines the profile of the cam 33 whose shape will be set out in detail below.

The two ends 71, 72 of the C-shaped edge 63 are spaced apart at a distance which corresponds to the height, along the axis Z, of the opening 53, in order to allow the engagement of the male member 11 in the inner space of the cam which is delimited by the edges 63. In this manner, the ends 71, 72 of the C-shaped edge together define an opening 73 for introduction of the bar 17, which corresponds to the opening 53.

On the other hand, the first cam portion 33A is formed with a central shaft 75 which forms the axis of rotation Y of the cam. This shaft 75 protrudes from the plate 61A, in the same direction as the edge 63 and over a greater length.

At the free end thereof, the shaft 75 is provided with a shape 77 for driving in terms of rotation, in this instance a square driving member, which complements a square central hole 79 formed in the plate 61B of the second cam portion 33B.

In an intermediate portion, the shaft 75 is formed with two planar portions 81 which are mutually symmetrical relative to an axial plane of the shaft.

Furthermore, the first cam portion 33 is provided with a hole 83 which opens at the side of the spring 35 and which receives the second end 85 thereof.

The lock 37 generally has a recessed parallelepipedal shape, comprising two opposing upper and lower symmetrical walls 90 which are planar at the outer side, a front wall 91 and a rear wall 92.

The walls 90, 91, 92 together define a through-recess 93. The walls 90 have, at the inner side, opposing recesses 95 which define a contraction of the recess 93, and two opposing planar faces 97 which are provided in order to each co-operate with a respective planar portion 81 of the shaft 75. The widest cross-section of the recess 93 is provided so that the shaft 75 can rotate freely through the lock 37. The lock 37 is mounted between the two cam portions 33A, 33B.

The lock 37 is mounted in the body 31 between the walls 51 and is shaped so as to be able to slide freely along the axis X, the two opposing walls 90 of the lock being supported in a sliding manner on the walls 51 and being guided thereon.

It should further be noted that the threaded rod 41 is provided with an axial through-conduit 101 which opens in the compartment 45 between the walls 51, opposite the lock 37. This axial conduit defines a hole for introduction of a tool which allows the lock to be moved from any premounted position to the initial operating position thereof, with inter-engagement of the planar faces 97 with the planar portions 81.

Furthermore, the face of the plate 61B directed towards the outer side of the body 31 comprises a marking 105, constituted in this instance by an impression in the form of a radial arrow. In a corresponding manner, the associated end edge of the cylindrical body 31 has fixed reference markings 107A, 107B, 107C (commonly designated 107), in this instance in the form of notches which are angularly offset. The movable marking 105 and fixed marking 107 together define means for indicating the angular position of the cam 33 relative to the fixed body 31, about the axis of rotation Y thereof.

These indication means 105, 107 allow the state of the fixing device 5 to be visualised.

With reference to FIG. 7, the profile of the cam 33 will now be described, defined by the inner surface 65 of the peripheral edge 63, in accordance with a preferred embodiment. It should first be noted that the torsion spring 35 and the cam 33 are designed in such a manner that the cam can rotate through approximately one quarter of a turn about the axis Y, between the initial standby position and the securing position thereof, as will be explained below.

Thus the cam profile has, between the end 71 and the axis Z, an active sector 110 which is capable of acting mechanically on the male member 11 and, between the axis Z and the end 72, a neutral sector 111, with no action on the male member 11.

It will be appreciated that the active sector 110 extends, in the example illustrated, over an angular sector of approximately 90°, whilst the neutral sector 111 extends over an angular sector of approximately 270°.

The neutral sector 111 corresponds to a portion of the profile in the form of a circular arc, centred on the axis of rotation Y of the cam, this portion of the profile extending from a path end point 115 for the male member, and the second end 72.

The active sector 110 which extends from the first end 71 to the path end point 115 successively has a linear entry portion 121, and an adjacent securing portion 122 which extends between the linear entry portion 121 and the path end point 115.

The linear portion 121 is inclined in such a manner that the distance to the axis of rotation Y of the cam decreases from the entry 71 to the point 125 of alignment of the two portions 121, 122.

This linear entry portion 121 is provided so as to provide the adjustment of the relative positioning clearances of the male and female members, substantially along the X axis, by approximately 4 mm relative to a nominal axial position.

The securing portion 122 in is the form of a circular arc which is off-centre relative to the axis of rotation Y of the cam 33.

The distance from the centre of curvature 130 of the circular arc portion 122 to the axis of rotation Y is selected to be very small, in particular very small relative to the radius of curvature and so as to produce securing of the male and female members progressively from the alignment point 125 to the path end point 115. The centre of curvature and the radius of curvature are selected so that the securing torque at the end of securing is substantially constant, regardless of the assembly variation of the male member relative to the female member, to within ±3 mm relative to the neutral axis X in the direction Z. “Substantially constant securing torque” is intended to refer to a torque variation of less than 15% or 9.5% and ideally as close as possible to 0% between the maximum securing torque and the minimum securing torque.

Owing to this arrangement, it is possible to avoid oversizing of the torsion spring relative to a predetermined nominal securing torque.

It should be noted that the securing portion 122 in the form of a circular arc extends over an angular sector of approximately 45°.

According to an alternative embodiment, which is not illustrated, the C-shaped edge may have a thickness which increases from the first to the second end thereof, so that the cam path has a profile which is generally helical.

With reference more specifically to FIGS. 3 to 6, the operation of the fixing device 5 will now be described.

Firstly, FIGS. 3 and 4 illustrate the initial configuration of the female member 12, awaiting engagement of the male member. This configuration is the one which is obtained following the operations for assembling the female member 12, which is carried out before the female member is mounted on the vehicle. These assembly operations will be described briefly below.

In the standby configuration illustrated in FIGS. 3 and 4, the two cam portions 33A, 33B are fixedly joined in terms of rotation by means of engagement of the square 77 in the hole 79, with a relative orientation such that the cam paths 65 are offset along the axis Y.

The cam 33 is positioned angularly in the body 31 so that the opening 73 is positioned opposite the opening 53.

In this position of the cam 33, the torsion spring 35 is tensioned and urges the cam in terms of rotation in a clockwise direction (in the views of FIGS. 3 and 4). The planar portions 81 extend horizontally (in the plane XY).

The cam 33 is locked in this standby position by the lock 37 counter to the biasing of the spring 35, by means of engagement of the inner planar faces 97 of the lock with the planar portions 81.

It should be noted that this engagement standby position is indicated visually by the coincidence of the movable marking 105 with a first fixed reference marking 107A.

As suggested by FIGS. 5 and 6, when the male member 11 is engaged in the female member 12, in order to fix the dashboard to the body portion of the vehicle, the bar 17 is introduced into the compartment 45 through the openings 53, 73 and comes into abutment against the rear face 92 of the lock 37.

The continuation of the engagement of the male member 11 in the female member 12 moves the lock 37 forwards in a sliding manner along the X axis, the lock being guided between the walls 51 and between the two cam portions 33A, 33B. The engagement is limited axially by the abutment of the annular stop 23 against the fixed body 31, at the periphery of the opening 53.

The insertion path of the male member 11 in the female member 12 is provided so that the lock 37 slides over a path greater than the length of inter-engagement of the planar faces 97 of the lock with the planar portions 81. In this manner, during the insertion of the male member in the female member, and before the annular stop 23 comes into abutment against the body 31, the lock 37 releases the shaft 75 in terms of rotation.

Under the effect of the biasing of the torsion spring 35, the cam 33 is driven in terms of rotation in the clockwise direction so that the cam path 65 moves into engagement with the cam follower which is constituted by the cambered rear face 25 of the bar 17.

The rotation of the cam 33, after the cam path 65 comes into contact with the cam follower 25, results in forward axial traction of the male member 11 and thus securing of the male member in the female member 12.

As will be appreciated on reading the above description, the action of the cam 33 on the male member 11 can be broken down, over the complete rotation of 90° of the cam, successively into an action for clearance adjustment under the action of the linear portion 121, and a securing action under the action of the portion 122 in the form of a circular arc. The linear portion 121 substantially adjusts the variation in X, to within 4 mm in the example illustrated. The securing action brought about by the portion 122 is accompanied by the adjustment of the variation of relative positioning in Z, to within ±3 mm in the example illustrated.

In the final securing position illustrated in FIGS. 5 and 6, the cam 33 is angularly offset relative to its reference position, to an angular extent which can be seen from the position of the marking 105 in alignment with one of the markings 107B, 107C, which indicate the securing.

The spring 35 is suitable so that, following a predetermined rotation of the cam 33, for example, through 90°, the torque which is still developed by the spring allows the desired axial securing force to be obtained. The secondary parameters taken into account in the sizing of the securing means in order to obtain the desired securing force include, for example, the shape of the cam path 65, the T-shaped hook 11, and the surface state of the cam path 65 and the cam follower 25. For example, these two surfaces may be coated with a material of the TEFLON® type in order to reduce occurrences of friction between the two components, which allows a smaller size of spring to be provided.

It should be understood that the fixing device 5 operates with the male member 11 being offset to a significant degree relative to the nominal engagement axis which is constituted by the axis of the opening 53, so that the fixing device allows the assembly clearances to be compensated for along the axes Y and Z.

The device 5 is further provided so as to operate with assembly clearances along the axis X which result in variations of the position of the end of the path for engagement of the male member 11 in the female member 12 along the axis X.

The activation of the securing means 33, 35, 37 during the engagement can be carried out over a range of relative axial positions of the male member and the female member.

The assembly of the female member 12 before it is fixed to the body portion 3 is carried out in accordance with the following main operations:
the torsion spring 35 is mounted on the cam portion 33A by engaging the end 85 of the spring in the hole 83;
the assembly formed in this manner is mounted in the body 31 by engaging the end 49 of the spring in the notch 47;
the lock 37 is mounted at the opposing end, between the walls 51, with the lock being fitted on the shaft 75;
the second cam portion 33B is mounted in the fixed body 31, by engaging the hole 79 on the square 77 and by aligning the edges 63 along the axis Y in order to form the opening 73;
the spring is primed by rotatably driving the square 77, as far as the neutral standby position of the cam 33, in which the opening 73 is positioned opposite the opening 53;
with the cam 33 being retained in a state locked in terms of rotation counter to the biasing force of the pretensioned spring 35, the lock 37 is moved into its locking position by being pushed axially backwards, using a tool which is introduced into the conduit 101.

This tool may be in the form of a simple rod which is brought into abutment with the front face 91 of the lock 37.

The female member 12 is then mounted in this configuration on the body portion of the vehicle, and fixed by means of securing the nut 43 on the threaded rod 41.

In an alternative embodiment, the male member 11 is welded to the “lower windscreen cross-member” or to the body portion 3, and the female member 12 is mounted on the “lower windscreen cross-member connection”, or more generally on the dashboard 1 by means of the threaded rod 41 and the complementary nut 43.

1. Device for automatically fixing a dashboard to a motor vehicle body, comprising:
a male member (11) which is fixedly joined to a first element (1) from the dashboard and the body, and
a female member (12) which is connected to the second element (3) from the dashboard and the body, and which is provided so as to receive the male member (11) with mutual engagement along an engagement axis (X),
characterised in that the female member (12) comprises axial securing means (33, 35, 37) which have automatic activation and which are activated by the engagement of the male member (11) in the female member (12), over a range of relative axial positions.

2. Device according to claim 1, characterised in that the male member (11) comprises an engagement portion (17) which forms a cam follower (25), and the securing means comprise an associated cam (33) which is mounted so as to rotate in a fixed body (31) of the female member (12), a resilient member (35) which is provided in order to urge the cam (33) in terms of rotation, and a releasable member (37) for locking the cam, which is provided in order to selectively lock the cam (33) in terms of rotation in a neutral standby position in which the cam (33) and the cam follower (25) can come into mutual engagement and in which the resilient member (35) is pretensioned, or release the cam (33) in order to bring about the securing, in accordance with the mutual engagement position of the male member (11) and the female member (12).

3. Device according to claim 2, characterised in that the locking member (37) is mounted so as to slide axially (X) in the fixed body (31) of the female member (12).

4. Device according to claim 3, characterised in that the cam (33) is fixedly joined to a shaft (75) which forms the axis of rotation (Y) thereof, the shaft (75) and the locking member (37) being provided with complementary shapes (81, 97) which can mutually engage in order to ensure that they are fixedly joined in terms of rotation, and disengage by means of relative axial displacement.

5. Device according to claim 3, characterised in that the fixed body (31) is provided with a hole (101) for introducing a tool, which is provided in order to place the locking member (37) in the locking position thereof when the female member (12) is assembled, the hole (101) being axially aligned with the locking member (37).

6. Device according to claim 2, characterised in that the fixed body (31) comprises a hollow cylindrical portion which is formed with an opening (53) for engagement of the male member (11), and in which the securing means (33, 35, 37) are arranged.

7. Device according to claim 2, characterised in that the cam (33) and the fixed body (31) are provided with visual means (105, 107) for indicating the angular position of the cam (33) about the axis of rotation (Y) thereof, which is indicative of the state of the securing means (33, 35, 37).

8. Device according to claim 5, characterised in that the fixed body (31) is provided at the outer side with a threaded rod (41) which allows the female member (12) to be fixed to the second element (3) by means of screwing.

9. Device according to claim 8, characterised in that the threaded rod (41) is formed with an axial conduit (101) which opens in the fixed body (31), and which defines the hole for introduction of the tool.

10. Device according to claim 2, characterised in that the cam (33) has a profile which has, successively, a linear entry portion (121) for clearance adjustment, and a securing portion (122) in the form of an arc of a circle which is off-centre relative to the axis of rotation of the cam (33).

11. Device according to claim 10, characterised in that the entry portion (121) and the securing portion (122) extend in an adjacent manner.

12. Device according to claim 1, characterised in that the cam (33) is provided so as to rotate through an angle substantially equal to 90°, between the neutral standby position and the final securing position thereof.

13. Device according to claim 1, characterised in that the male member (11) is fixed to the dashboard (1), whilst the female member (12) is fixed to the body (3).

14. Device according to claim 4, characterised in that the fixed body (31) is provided with a hole (101) for introducing a tool, which is provided in order to place the locking member (37) in the locking position thereof when the female member (12) is assembled, the hole (101) being axially aligned with the locking member (37).

15. Device according to claim 3, characterised in that the fixed body (31) comprises a hollow cylindrical portion which is formed with an opening (53) for engagement of the male member (11), and in which the securing means (33, 35, 37) are arranged.

16. Device according to claim 3, characterised in that the cam (33) and the fixed body (31) are provided with visual means (105, 107) for indicating the angular position of the cam (33) about the axis of rotation (Y) thereof, which is indicative of the state of the securing means (33, 35, 37).

17. Device according to claim 2, characterised in that the fixed body (31) is provided at the outer side with a threaded rod (41) which allows the female member (12) to be fixed to the second element (3) by means of screwing.

18. Device according to claim 3, characterised in that the fixed body (31) is provided at the outer side with a threaded rod (41) which allows the female member (12) to be fixed to the second element (3) by means of screwing.

19. Device according to claim 4, characterised in that the fixed body (31) is provided at the outer side with a threaded rod (41) which allows the female member (12) to be fixed to the second element (3) by means of screwing.

20. Device according to claim 3, characterised in that the cam (33) has a profile which has, successively, a linear entry portion (121) for clearance adjustment, and a securing portion (122) in the form of an arc of a circle which is off-centre relative to the axis of rotation of the cam (33).
